(19) United States
(12) Patent Application Publication
(10) Pub. No.: US 2021/0231320 A1
(43) Pub. Date: Jul. 29, 2021

(54) AN IMPROVED EVAPORATIVE AIR COOLER

(71) Applicant: SYMPHONY LIMITED, Ahmedabad (IN)

(72) Inventor: Achal A BAKERI, Ahmedabad (IN)

(21) Appl. No.: 16/970,791

(22) PCT Filed: Jan. 28, 2020
(86) PCT No.: PCT/IN2020/050092

§ 371 Date: Aug. 18, 2020

(30) Foreign Application Priority Data
Feb. 2, 2019 (IN) 201921004169

(51) Int. Cl. F24F 5/00; F24F 13/20

(52) U.S. Cl. CPC F24F 5/0035; F24F 13/20

(57) ABSTRACT

The present invention provides an evaporative air cooler (10). The evaporative air cooler (10) facilitates multi directional discharge of air. The evaporative air cooler (10) provides structurally rigid interchangeable air discharge panels that are easy to assemble. The improved evaporative air cooler (10) unit provides a multi directional discharge of air by providing the multi-panel construction. The multi-panel construction includes a top panel (11) located on the top of the evaporative air cooler (10) for water storage, a bottom panel (12) located on the bottom or top of the air cooler for air discharge form bottom side of the cooler and a plurality of side panels (13) located on the sides of evaporative air cooler (10). The top panel (11), the bottom panel (12) and the plurality of side panels (13) forms the housing of the evaporative air cooler (10).

### FIELD OF INVENTION

The present invention relates to an improved evaporative air cooler and more particularly, relates to an air cooler with improved air discharge system facilitating multi directional discharge of air as per user/site requirement.

### BACKGROUND OF INVENTION

Evaporative air cooler is an efficient and sustainable method for cooling. Evaporative air cooler function best in the drier climatic conditions, and performs cooling by evaporating water into a stream of air and delivering the cooled air to the space to be cooled. A conventional evaporative air cooler includes an internal fan or blower, pillar, top panel, tank and side panel generally of the squirrel cage type, having a sheet metal or plastic. The fan/blower shroud is connected by appropriate structure usually to a tank or side panel and communicates with a cooled air outlet. Due to the specific type of arrangement of conventional apparatus, the evaporative air coolers have less structural rigidity.

The conventional evaporative air coolers often require air outlet to be on top or bottom or side of an air cooler, depending upon the use area and the application. Thus, the consumers have to pre-select a model as per their requirement. After having selected a model, there is no flexibility for changing the style of use for different direction of air discharge.

The conventional evaporative air cooler have openings in the side panels for the discharge of air from the outside, into the blower or fan with some form of water wicking or spray apparatus The conventional apparatus of evaporative air cooler have requirements of assembling different parts for making side discharge and bottom discharge type air coolers. Therefore, there is an inconvenience in making different assembly for different discharge types of air cooler system.

In conventional apparatus of evaporative air cooler, the air outlet is always fixed at the front or side or back or top or bottom. Thus, the conventional apparatus does not have a flexibility of choosing air outlet side of the evaporative cooler.

### PRIOR ART

Korean Patent Application KR200312142 relates to room air conditioners having front panel and the top panel gaepae structure. The room air conditioners is provided with a front panel and a top panel, a suction port in the indoor unit provided with air conditioning, a hinge on one side for opening and closing the front panel by the top cover. The top cover and the front cover is connected to a hinge on one side to gaepae, the front panel with a drive member for the upper cover and front cover provides rotational power for the opening and closing operation, the drive member and the first rack gear and the second rack gear. The first rack gear and the upper cover one end and the other end is hinged connected to the first rotation arm and the second rack gear consists of a second rotary arm connected to each of the hinge to the front cover.

However, it includes two sides opening for air discharge, vis-à-vis in the front panel and the top panel and thus, fails to teach the universal/multi air discharge system. The components included in the invention are neither interchangeable nor detachable. Therefore, it fails to provide universality of the air discharge system.

Another U.S. Pat. No. 3,680,328A relates to an improved air-conditioner. The air-conditioner comprises a casing means, mountable within an opening into a room, an air-conditioning means contained within the casing, and a blower means contained within the casing for drawing air from the room into the casing and proximate to the air conditioning means for conditioning thereby, and then discharging the conditioned air to the room. However, in particular accordance with the present invention, the blower means, that is contained within the air-conditioner, has an impeller rotatable journal led between two spaced apart blower housing walls and is provided with scroll means that can perform a dual function of bridging the two housing walls and also providing a plurality of air discharge ports from the blower housing.

However, said prior art relates to improved air-conditioner or self-contained air-conditioner units which includes casing on the top, bottom, front and side walls but fails to provide universal/multi panel construction. The self-contained air-conditioner units are frequently employed to condition the air within a single residential room or confined space and are widely referred to as “room air conditioners”. Thus, the prior art fails to provide universal air discharge system and also does not provide flexibility, detachability and interchangeability.

### Disadvantage of Prior Art

The above-mentioned prior art suffers from all or at least one of the following disadvantages:
Most of the air coolers provide an air outlet to be on top or bottom or side of an air cooler depending upon use of area and application and thereby fail to provide air cooler that discharges air in all three directions.
Most of the air coolers fail to provide a flexible air cooler that discharges air in all three directions.
Most of the air coolers lack multi panel construction.
The air coolers fail to provide panels that can be easily interchanged and be assembled.
Most of the air coolers do not have the flexibility to change the direction of panels as per need of the user or site and hence are not user friendly.
Most of the air coolers have less structural rigidity due to their arrangements of existing components.
Many of the air coolers fail to provide multiple assemblies for multi directional air discharge and therefore, are not efficient.
Most of the air coolers have number of additional parts which leads to an increase in the cost of the model.

Thus, there is an unmet need for developing an air cooler that obviates the problems associated with prior art.

### OBJECTS OF THE INVENTION

The main object of the present invention is to provide an evaporative air cooler.

Another object of the present invention is to provide an evaporative air cooler that facilitates multi directional discharge of air as per user/site requirement.

Another object of the present invention is to provide an evaporative air cooler that provides flexible and detachable multiple air discharge panels that facilitates multi directional discharge of air as per user/site requirement and therefore is efficient.

Another object of the present invention is to provide an evaporative air cooler that provides interchangeable air discharge panels and therefore is efficient and user friendly.

Another object of the present invention is to provide an evaporative air cooler that provides interchangeable air discharge panels that are easy to assemble and hence is user friendly.

Another object of the present invention is to provide an evaporative air cooler with better structural rigidity.

Another object of the present invention is to provide an evaporative air cooler that provides different air discharge outlet without using additional component parts and therefore, is substantially efficient and also cost effective.

Another object of the present invention is to provide an economical evaporative air cooler.

### BRIEF DESCRIPTION OF DRAWINGS

FIG. 1 illustrates a perspective view of an evaporative air cooler (10), according to an embodiment herein;

FIG. 2 illustrates a perspective view of the evaporative air cooler (10) having a plurality of side panels (13), according to an embodiment herein;

FIG. 3 illustrates a sectional view of a portion of the evaporative air cooler (10), according to an embodiment herein; and

FIG. 4 illustrates an underside of the air discharge panel of the evaporative air cooler (10), according to an embodiment herein.

### DESCRIPTION OF INVENTION

The present invention provides the evaporative air cooler (10). The present invention provides the evaporative air cooler (10) for facilitating multi directional discharge of air at the same time. The present invention provides structurally rigid, interchangeable air discharge panels capable of easy to assemble and dis-assemble.

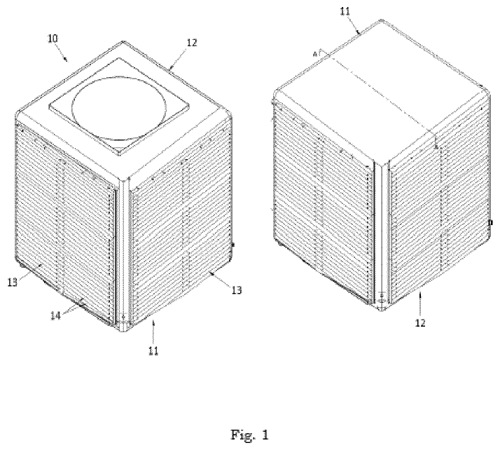

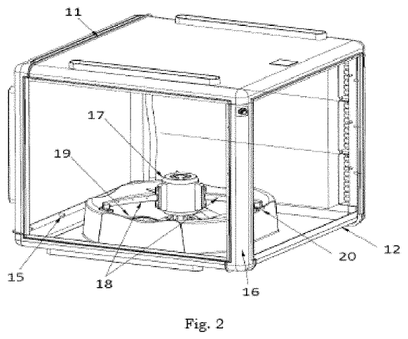

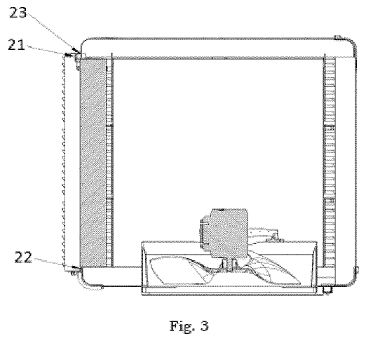

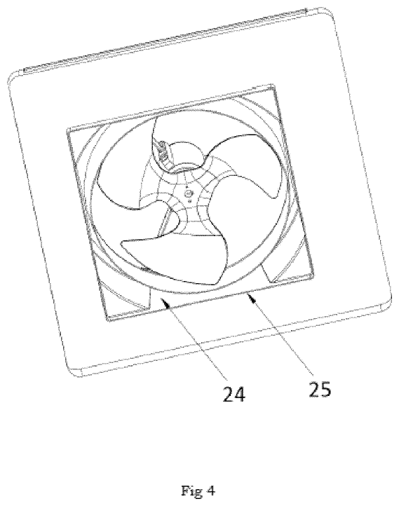

FIG. 1 to FIG. 4 illustrates the improved evaporative air cooler (10) comprising a top panel (11), a bottom panel (12), the plurality of side panels (13), a plurality of air inlet opening (14), a boss (15), a plurality of pillars (16), a motor (17), a bracket (18), a blower housing/shroud (19), a locating stops (20), at least one tab (21), at least one recess (22), a vertical flange (23), an air exit opening (24) and an extension flange (25).

The evaporative air cooler (10) unit provides a multi directional discharge of air by providing the multi-panel construction. In an embodiment, the evaporative air cooler (10) is made up of a non-conductor material. The multi-panel construction includes t h e top panel (11) placed at the top of the evaporative air cooler (10). In an embodiment, the top panel (10) is capable of storing water. The top panel (11) is connected to the plurality of side panels (13) and the plurality of pillars (16). In an embodiment, the top panel (11) is connected to the plurality of pillars (16) through a connecting means. In a preferred embodiment, the top panel (11) is connected to the plurality of pillars (16) by horizontally extending bolts or self-tapping screws. In an embodiment, the bolts and the self-tapping screws are made of a non-corrosible metal, such as, but not limited to, brass.

The bottom panel (12) is located at the bottom or at t h e top of the evaporative air cooler (10). The bottom panel (12) is connected to the plurality of side panels (13) and the plurality of pillars (16). In an embodiment, the bottom panel (12) is connected to the plurality of pillars (16) near the corners of the evaporative air cooler (10). The bottom panel (12) includes the air exit opening (24) for the discharge of cold air and the extension flange (25) for the installation of external unit duct. In an embodiment, the bottom panel (12) is placed adjacent to the extension flange (25). In an embodiment, the bottom panel (12) is capable of discharging air from the bottom side of the evaporative air cooler (10).

The plurality of pillars (16) is capable of connecting the top panel (11) with the bottom panel (12). In an embodiment, the plurality of pillars (16) is a longitudinal, hollow pipe like structures. In an embodiment, the plurality of pillars (16) are four in number. In an embodiment, the plurality of pillars (16) is capable of providing the structural strength to the evaporative air cooler (10).

The plurality of side panels (13) are located on all the four sides of the evaporative air cooler (10). In an embodiment, the plurality of side panels (13) forms the air discharge arrangement unit of the evaporative air cooler (10). The plurality of side panels (13) are connected to the plurality of pillars (16), the top panel (11) and the bottom panel (12). The plurality of side panels (13) are connected to the bottom panel (12) through the boss (15). In an embodiment, the boss (15) is placed at the bottom panel (12). In a preferred embodiment, the boss (15) is placed at the top side of the bottom panel (12). The plurality of side panels (13) are connected to the top panel (11) through at least one tab (21). In an embodiment, at least one tab (21) and the plurality of side panels (13) are connected through at least one recess (22). In a preferred embodiment, the boss (15), at least one tab (21) and at least one recess (22) provides universal mounting arrangement of the evaporative air cooler (10).

In an embodiment, the plurality of side panels (13) rests against the vertical flange (23) of the top panel (11). In an embodiment, the plurality of side panels (13) and the vertical flange (23) overlap each other. In a preferred embodiment, the overlapping of the vertical flange (23) and the plurality of side panels (13) prevents leakage of air from the sides of the evaporative air coolers (10).

In an embodiment, at least one tab (21) and the vertical flange (23) forms the universal mounting arrangement. In an embodiment, at least one tab (21) and the vertical flange (23) are detachable, for providing a multi-directional discharge of air. In a preferred embodiment, at least one tab (21) and the vertical flange (23) can be detached, for providing the discharge of air as per the requirement of the user.

The plurality of side panels (13) includes the air inlet opening (14). The air inlet opening (14) is connected to the plurality of pillars (16). In an embodiment, the air inlet opening (14) are multiple in number. In a preferred embodiment, the air inlet opening (14) covers the entire surface of the plurality of side panels (13). In an embodiment, the air inlet opening (14) is capable of receiving warm air into the housing of the evaporative air coolers (10).

The air inlet opening (14) forms a louver structure in the plurality of side panels (13). In an embodiment, the louver structure has a slope. In an embodiment, the slope of the louver structure is inclined backwards into the housing of the evaporative air cooler (10). In an embodiment, the water may collect in the louver structure of the plurality of side panels (13). The slope of the louver structure is capable of directing the flow of water backwards into the housing of the evaporative air cooler (10). In an embodiment, the slope is capable of preventing the flow of water out from the plurality of side panels (13).

The water is mixed with the incoming warm air and is evaporated. In an embodiment, the water absorbs the heat of the incoming warm air. The mixing of the water with the incoming warm air leads to the cooling of air. In an embodiment, the cooled or moistened air is blown out from the bottom panel (12), the top panel (11) and the plurality of side panels (13). In an embodiment, the cool air is blown out from a combination of the top panel (11), the bottom panel (12) and the plurality of side panels (13) of the evaporative air cooler (10).

In an embodiment, the plurality of side panels (13), the top panel (11) and the bottom panel (12) forms the housing of the evaporative air cooler (10). In an embodiment, the housing of the evaporative air cooler (10) is made of materials like, but not limited to, plastic, sheet and casting metal.

The evaporative air cooler (10) includes the blower housing (19) mounted on the bottom panel (12). In an embodiment, the blower housing (19) is molded of a structural foam material reinforced with engineering plastic.

The bracket (18) is mounted on the blower housing (19). In an embodiment, the blower housing (19) and the bracket (18) are mounted on the bottom panel (12) through a connecting means. In a preferred embodiment, the connecting means are a bolt and a self-tapping screws. In an embodiment, the bolt and the self-tapping screws are made of a non-corrosible metal, such as, but not limited to, brass.

In an embodiment, the motor (17) is mounted on the bracket (18). In a preferred embodiment, the motor (17) is mounted on the bracket (18) through the locating stops (20). In a preferred embodiment, the bracket (18) is capable of holding a plurality of evaporative pads in a fixed position. In an embodiment, the bracket (18) provides support to the motor (17). The motor (17) is configured for providing power for the rotation of the fan and pumping of water to the plurality of evaporative pads.

The water distribution system in the evaporative air cooler (P) includes a drip canal in the integrally molded structure, just below the drip slots is a part of water distribution of the trough, to direct water into the pad and keep water from running down the front of the side panel (13).

### ADVANTAGES OF PRESENT INVENTION

The present invention has many advantages over the prior art:
1. The present evaporative air cooler (10) evaporative air cooler (10) enables multi directional discharge of air as per user/site requirement.
2. The present evaporative air cooler (10) is flexible and has detachable multiple air discharge panels for facilitating multi directional discharge of air as per user/site requirement.
3. The present evaporative air cooler (10) has interchangeable air discharge panels and therefore is efficient and user friendly.
4. The present evaporative air cooler (10) provides an evaporative air cooler (10) with interchangeable air discharge panels that are easy to assemble
5. The present evaporative air cooler (10) has better structural rigidity.
6. The present evaporative air cooler (10) is provided with different air discharge outlet without using additional component parts and therefore is substantially efficient and also cost effective.
7. The present evaporative air cooler (10) is economical.

We claim:

1. An evaporative air cooler (10) for multi directional discharge of air comprising:
a top panel (11) connected to a plurality of side panels (13) and a plurality of pillars (16), wherein the top panel (11) is configured for water storage;
a bottom panel (12) connected to the plurality of side panels (13) and the plurality of pillars (16), wherein
the bottom panel (12) is configured for discharging air from the bottom side of the evaporative air cooler (10) through an air exit opening (24);
an extension flange (25) connected to the air exit opening (24), wherein the extension flange (25) is configured for providing duct mounting;
the plurality of pillars (16) connects the top panel (11) and the bottom panel (12), wherein the plurality of pillars (16) is configured for providing the structural strength to the evaporative air cooler (10);
the plurality of side panels (13) are connected to the top panel (11) through at least one tab (21) and to the bottom panel (12) through at least one recess (22) and are placed adjacent to the plurality of pillars (16);
a plurality of air inlet opening (14) is located in the plurality of side panels (13), wherein the plurality of air inlet opening (14) is configured for
receiving warm air into the evaporative air cooler (10),
forming a louver structure having a slope;
a boss (15) placed on the bottom panel (12), wherein the boss (15) is configured for attaching the plurality of side panels (13) to the bottom panel (12);
a vertical flange (23) placed on the top panel (11), wherein the vertical flange (23) is configured for attaching the plurality of side panels (13) to the top panel (11); and
a blower housing (19), placed at the bottom panel (12), comprises a motor (17), a bracket (18) and a fan, wherein
the bracket (18) is mounted on the blower housing (19) through a locating stops (20),
the bracket is capable of holding an evaporative pad in a fixed position, and
the motor (17) is mounted on the bracket (18) of the blower housing (19).

2. The evaporative air cooler (10) as claimed in claim 1, wherein the evaporative air cooler (10) is made of one of a non-conductor material.

3. The evaporative air cooler (10) as claimed in claim 1, wherein the plurality of pillars (16) are four in number.

4. The evaporative air cooler (10) as claimed in claim 1, wherein at least one tab (21) and the vertical flange (23) forms the universal mounting arrangement.

5. The evaporative air cooler (10) as claimed in claim 1, wherein at least one tab (21) and the vertical flange (23) facilitates multi-directional discharge of air.

6. The evaporative air cooler (10) as claimed in claim 1, wherein the louver structure is inclined backward into the evaporative air cooler (10).

7. The evaporative air cooler (10) as claimed in claim 1, wherein the blower housing (19) is made of a structural foam material.

8. The evaporative air cooler (10) as claimed in claim 1, wherein the bracket (18) and the motor (17) are mounted on the blower housing (19) through at least one connecting means.

9. The evaporative air cooler (10) as claimed in claim 1, wherein the connecting means is a bolt and a self-tapping screws.

10. The evaporative air cooler (10) as claimed in claim 1, wherein the motor (17) is capable of providing power for the rotation of the fan and for pumping of water.
